(19) United States
(12) Patent Application Publication
(10) Pub. No.: US 2023/0053482 A1
(43) Pub. Date: Feb. 23, 2023

(54) COMPOSITE INSERTS FOR A ROTOR LAMINATION

(71) Applicant: GM Global Technology Operations LLC, Detroit, MI (US)

(72) Inventors: Derek Frei Lahr, Howell, MI (US); Anthony Michael Coppola, Rochester Hills, MI (US); Alireza Fatemi, Canton, MI (US)

(21) Appl. No.: 17/408,889

(22) Filed: Aug. 23, 2021

(51) Int. Cl. H02K 1/30; H02K 15/03; H02K 1/27

(52) U.S. Cl. CPC H02K 1/30; H02K 15/03; H02K 1/278; H02K 2201/09

(57) ABSTRACT

A rotor lamination for an electric machine includes a body having a first axial surface, a second axial surface, a central opening, and an outer annular edge defining a radius. A plurality of magnet receiving openings are formed in the body. Each of the plurality of magnet receiving openings includes a first magnet receiving portion and a second magnet receiving portion. A composite insert is mounted in the body. The composite insert extending along the radius across the magnet receiving opening physically separating the first magnet receiving portion from the second magnet receiving portion.

### INTRODUCTION

The subject disclosure relates to the art of electric machines and, more particularly to composite inserts for a rotor lamination in an electric machine.

Rotors are typically formed from multiple stacked laminations which support a central hub and a plurality of magnets. Generally, each lamination includes multiple openings that create webs and which serve as cooling passages, magnet mounting locations and the like. Openings are also placed so as to reduce rotor weight and promote balance. The webs act as flux leakage paths which can reduce performance or increase operational costs of the electric machine.

Magnets are often inserted into the openings and held in place with an adhesive, such as an epoxy. In such cases, the openings will often include corrugated edges that help retain the magnets and enhance retention of the epoxy. In many cases, the epoxy does not bond to the magnets and simply serves as, for example, a wedge that prevents the magnets from moving. Magnet retention, flux leakage, and structural support are issues that may limit an overall operating speed of the rotor. Accordingly, it would be desirable to provide a rotor with structural support that can stabilize the magnets, reduce flux leakage, and enhance stiffness so that the rotor may accommodate high speed operations.

### SUMMARY

Disclosed is a rotor lamination for an electric machine including a body having a first axial surface, a second axial surface, a central opening, and an outer annular edge defining a radius. A plurality of magnet receiving openings are formed in the body. Each of the plurality of magnet receiving openings includes a first magnet receiving portion and a second magnet receiving portion. A composite insert is mounted in the body. The composite insert extending along the radius across the magnet receiving opening physically separating the first magnet receiving portion from the second magnet receiving portion.

In addition to one or more of the features described herein the body includes a first thickness and the composite insert includes a second thickness that is greater than the first thickness.

In addition to one or more of the features described herein the body is formed from a first material and the composite insert is formed from a second material, the second material being distinct from the first material.

In addition to one or more of the features described herein the composite insert is formed from a plurality of resin impregnated layers, each of the plurality of resin impregnated layers including a plurality of fibers, at least a portion of the plurality of fibers extend along the radius of the body.

In addition to one or more of the features described herein a first magnet is arranged in the first magnet receiving portion and a second magnet is arranged in the second magnet receiving portion.

In addition to one or more of the features described herein a first amount of adhesive is arranged in the first magnet receiving portion and a second amount of adhesive arranged in the second magnet receiving portion. The first and second amounts of adhesive bond the composite insert, the first magnet, and the second magnet to the body.

In addition to one or more of the features described herein the composite insert includes a first end portion, a second end portion, and an intermediate portion extending between the first end portion and the second end portion, each of the first end portion and the second end portion including magnetic particles.

In addition to one or more of the features described herein the composite insert includes a magnetic particle layer that includes a magnet field having a direction of magnetization that is substantially the same as a net magnetic field of the rotor lamination.

Also disclosed is an electric machine including a housing, a stator mounted to the housing, and a rotor rotatably mounted in the housing and surrounded by the stator. The rotor is formed from a plurality of rotor laminations. Each of the plurality of rotor laminations includes a body having a first axial surface, a second axial surface, a central opening, and an outer annular edge defining a radius. A plurality of magnet receiving openings is formed in the body. Each of the plurality of magnet receiving openings includes a first magnet receiving portion and a second magnet receiving portion. A composite insert is mounted in the body. The composite insert extends along the radius across the magnet receiving opening physically separating the first magnet receiving portion from the second magnet receiving portion.

In addition to one or more of the features described herein the body includes a first thickness and the composite insert includes a second thickness that is greater than the first thickness.

In addition to one or more of the features described herein the body is formed from a first material and the composite insert is formed from a second material, the second material being distinct from the first material.

In addition to one or more of the features described herein the composite insert is formed from a plurality of resin impregnated layers, each of the plurality of resin impregnated layers including a plurality of fibers, at least a portion of the plurality of fibers extending along the radius of the body.

In addition to one or more of the features described herein a first magnet is arranged in the first magnet receiving portion and a second magnet is arranged in the second magnet receiving portion.

In addition to one or more of the features described herein a first amount of adhesive is arranged in the first magnet receiving portion and a second amount of adhesive is arranged in the second magnet receiving portion. The first and second amounts of adhesive bond the composite insert, the first magnet, and the second magnet to the body.

In addition to one or more of the features described herein one or more of the plurality of laminations includes an adhesive material arranged on the body, the adhesive material joining the one or more of the plurality of laminations to others of the plurality of laminations.

In addition to one or more of the features described herein the composite insert includes a first end portion, a second end portion, and an intermediate portion extending between the first end portion and the second end portion, each of the first end portion and the second end portion including magnetic particles.

In addition to one or more of the features described herein the composite insert includes a magnetic particle layer that includes a magnet field having a direction of magnetization that is substantially the same as a net magnetic field of the rotor lamination.

Further disclosed is a method of forming a rotor for an electric machine including installing a composite insert into each of a plurality of magnet receiving openings formed in a body of a rotor lamination, the composite insert extending along a radius of the body, aligning a plurality of rotor laminations, and compressing the plurality of rotor laminations causing each composite insert to lock into the body.

In addition to one or more of the features described herein adhesive is added to the body of one or more of the plurality of laminations.

In addition to one or more of the features described herein compressing the plurality of rotor laminations reduces a thickness of the composite insert.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a cross-sectional side view of an electric machine having a rotor, in accordance with a non-limiting example;

FIG. 2 is a partial perspective view of the rotor of FIG. 1, in accordance with a non-limiting example;

FIG. 3 is an axial end view of the rotor of FIG. 2, in accordance with a non-limiting example;

FIG. 4 is a partial axial view of a rotor lamination depicting a composite insert spanning a magnet receiving opening in the rotor of FIG. 3, in accordance with a non-limiting example;

FIG. 5 is an end view of a composite insert, in accordance with a non-limiting example;

FIG. 6 is a partial axial view of a rotor lamination depicting a composite insert spanning magnet receiving openings, in accordance with another non-limiting example;

FIG. 7 is a partial axial view of the rotor lamination of FIG. 4 depicting a composite insert spanning a magnet receiving opening prior to insertion of magnets, in accordance with a non-limiting example;

FIG. 8 is a partial axial view of the rotor lamination of FIG. 7 depicting a composite insert spanning a magnet receiving opening after to insertion of magnets, in accordance with a non-limiting example;

FIG. 9 depicts a side view of a plurality of rotor laminations prior to compression, in accordance with a non-limiting example;

FIG. 10 depicts a side view of the plurality of rotor laminations of FIG. 9 after compression, in accordance with a non-limiting example;

FIG. 11 depicts a partial axial view of a composite insert, in accordance with another non-limiting example; and

FIG. 12 depicts a partial axial view of a composite insert, in accordance with yet another non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

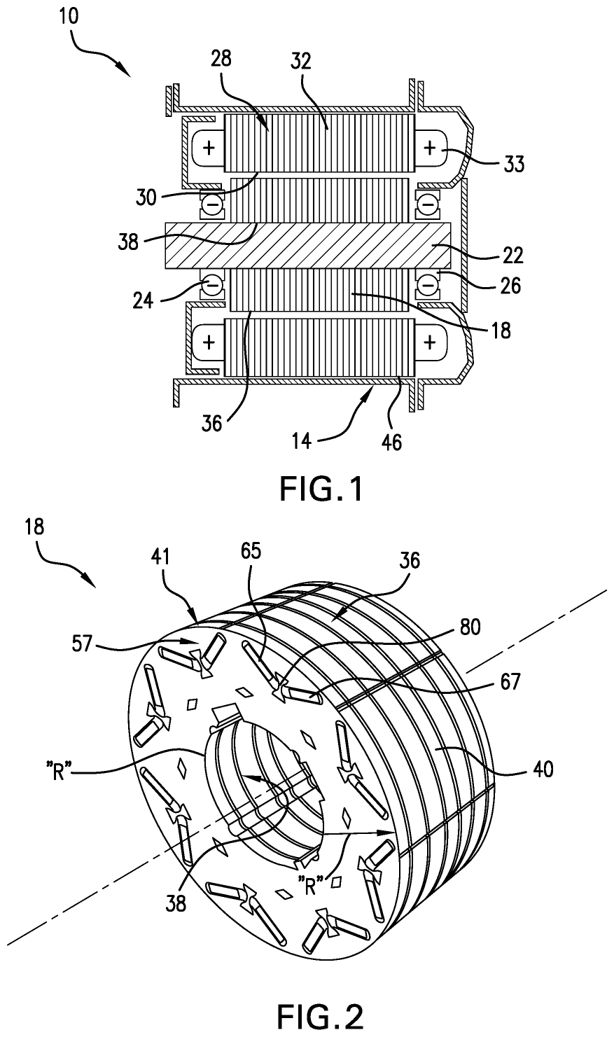

An electric machine, in accordance with a non-limiting example, is indicated generally at 10 in FIG. 1. Electric machine 10 includes a housing 14 that rotatably supports a rotor 18 mounted to a shaft 22. Shaft 22 is supported in housing 14 by a first bearing 24 and a second bearing 26. A stator 28 is mounted to housing 14 about rotor 18. Stator 28 includes an annular inner surface 30 that is spaced from rotor 18. Stator 28 is formed from a plurality of stator laminations 32 and supports a stator winding 33.

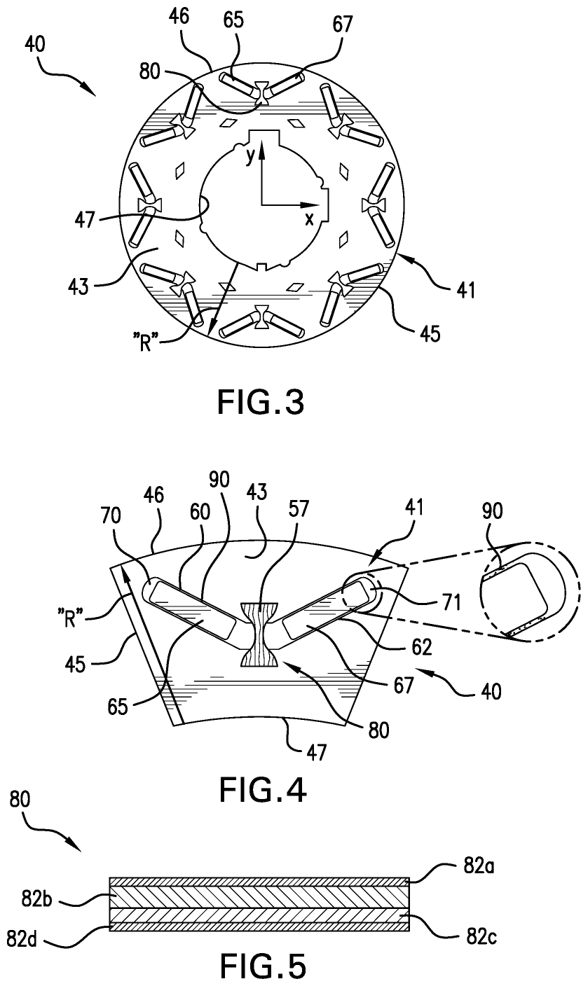

Reference will now follow to FIGS. 2 and 3 with continued reference to FIG. 1 in describing rotor 18 in accordance with a non-limiting example. Rotor 18 includes an outer rotor surface 36 that is spaced from annular inner surface 30 of stator 28 and an inner surface 38. A radius “R” extends from inner surface 38 to outer rotor surface 36. Rotor 18 is formed from a plurality of laminations 40. Each lamination 40 includes a body 41 having a first axial surface 43 and a second opposing axial surface 45 (FIG. 10). Each lamination 40 includes an outer edge 46 that contributes to forming outer rotor surface 36 and an inner edge 47 that defines a central opening (not separately labeled) and contributes to forming inner surface 38.

Each rotor lamination 40 also includes a plurality of magnet receiving openings 57 that are arranged between outer edge 46 and inner edge 47. Referring to FIG. 4, and with continued reference to FIGS. 2-3, each magnet receiving opening 57 includes a first magnet receiving portion 60 and a second magnet receiving portion 62. A first magnet 65 is provided in first magnet receiving portion 60 and a second magnet 67 is provided in second magnet receiving portion 62. A first air buffer 70 is defined in first magnet receiving portion 60 outwardly of first magnet 67 and a second air buffer 71 is defined in second magnet receiving portion 62 outwardly of corresponding second magnet 66. Air buffers 70 and 71 serve as a flux barrier that limits unwanted flux transfer across rotor 18.

In accordance with a non-limiting example, a composite insert 80 is mounted in rotor lamination 40 in each magnet receiving opening 57. Composite insert 80 spans and bisects each magnet receiving opening 57. Composite insert 80 extends along radius “R” of rotor lamination 40 and includes a narrow central section (not separately labeled) and wider end sections (also not separately labeled). The wider end sections are embedded in lamination 40 and collectively form an hour glass shape. Each composite insert 80 may be formed from a plurality of resin impregnated layers such as shown at 82a, 82b, 82c, and 82d in FIG. 5. Each resin impregnated layer 82a-82d may include fibers that extend in different directions. At least one of the layers 82a-82d includes fibers that extend along radius “R” such as shown at 57 in FIG. 4. Composite inert 80, first magnet 65 and second magnet 67 may be retained in magnet receiving opening 57 with an amount of adhesive 90.

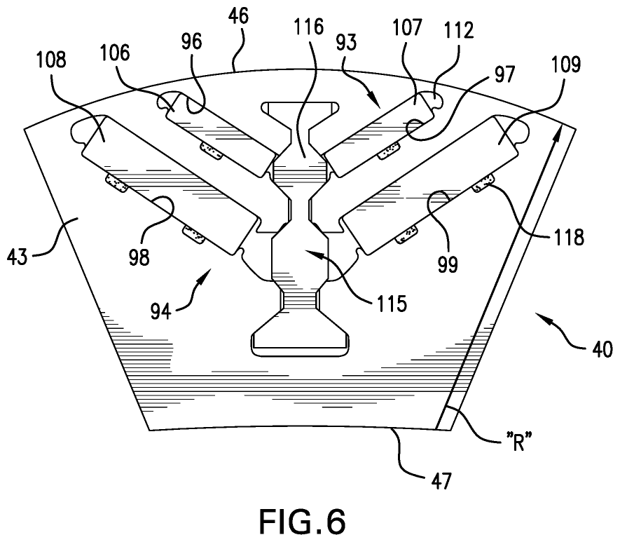

Reference will now follow to FIG. 6 in describing a rotor lamination 40 in accordance with another non-limiting example. Rotor lamination 40 includes a first plurality of magnet receiving openings 93 disposed adjacent to outer edge 46 and a second plurality of magnet receiving openings 94 disposed adjacent to inner edge 47. First plurality of magnet receiving openings 93 are spaced from second plurality of magnet receiving openings 94 along radius ‘R”.

Each of the first plurality of magnet receiving openings 93 includes a first magnet receiving portion 96 and a second magnet receiving portion 97. Likewise, each of the second plurality of magnet receiving openings 94 includes a third magnet receiving portion 98, and a fourth magnet receiving portion 99. A first magnet 106 is provided in first magnet receiving portion 96, a second magnet 107 is provided in second magnet receiving portion 97, a third magnet 108 is provided in third magnet receiving portion 98, and a fourth magnet 109 is provided in fourth magnet receiving portion 99. Air buffers, such as shown at 112, are disposed outwardly of each magnet 106-109.

In a non-limiting example, a composite insert 115 extends along radius “R” and spans first magnet receiving opening 93 and second magnet receiving opening 94. Composite insert 115 includes a plurality of projections, one of which is indicated at 116 that extend into each one of the first, second, third, and fourth magnet receiving portions 96-99. Projections 116 aid in composite insert retention and also help support radial forces on rotor 18. In a manner similar to that discussed herein, an amount of adhesive 118 may be employed to retain each magnet 106-109 as well as composite insert 115. In a manner also similar to that discussed herein, composite inserts 115 may be formed from a plurality of resin impregnated layers.

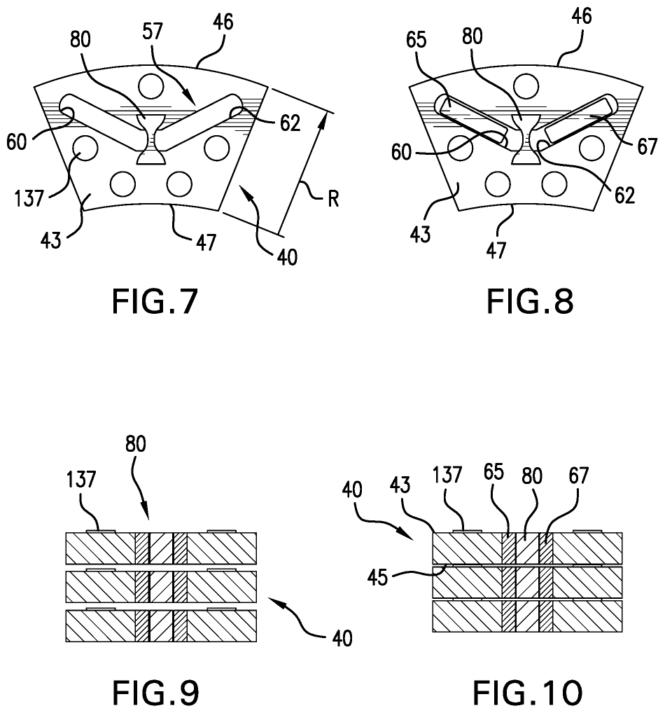

Reference will now follow to FIGS. 7-10 in describing a method of forming rotor 18. As shown in FIG. 7, composite inserts 80 are installed into rotor lamination 40 across each magnet receiving opening 57 along radius “R”. Composite insert 80 may have a thickness that is greater than a thickness of lamination 40. That is, lamination 40 may have a first axial thickness and composite insert 80 may have a second thickness that is greater than the first axial thickness of lamination 40. Further, lamination 40 may be formed from a first material, such as a metal, and composite insert 80 may be formed from a different material. The different material may be non-electrically and/or non-magnetically conducting.

In further accordance with a non-limiting example, glue dots, such as shown at 137, are positioned on first axial surface 43 and, as shown in FIG. 8, magnets 65 and 67 may be installed into each magnet receiving portion 60, 62. In a non-limiting example, laminations 40 may be stacked as shown in FIG. 9 with each composite insert 80 being in alignment. Once a select number of laminations 40 are stacked and aligned, a compressive force is applied. The compressive force bonds each lamination to another forming portion of rotor 18 as shown in FIG. 10. At this point, it should be understood that the number of laminations in each portion of rotor portion 18 may vary and could include less than all the laminations used to form rotor 18. Further, while described as inserting magnets into each lamination, magnet installation may take place after stacking, aligning, and compressing.

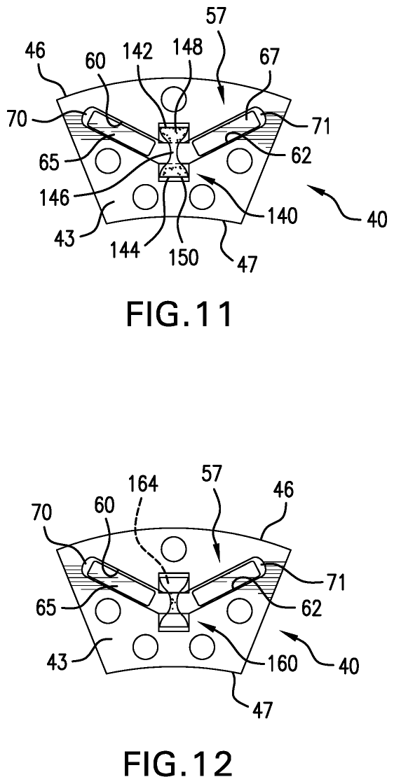

In accordance with another non-limiting example depicted in FIG. 11, a composite insert indicated at 140 may include a first end portion 142, a second end portion 144, and an intermediate portion 146. First and second end portions 142 and 144 include magnetic particles 148 and 150 respectively. In one non-limiting example, intermediate portion 146 is non-magnetic. Magnetic particles 148 and 150 enhance rotor performance by replacing magnetically conductive material that may be lost when composite adding insert 100.

FIG. 12 depicts a composite insert 160 including a magnetic particle layer 164 that is aligned with the magnetic field of rotor 18. Magnetic particle layer 164 may improve rotor performance by being formed from a material that supports portions of rotor lamination 40 about composite insert 160. Further, the use of magnetic material in magnetic particle layer 164 allows composite insert 160 to function as a permanent magnet to enhance magnetic field distribution across rotor lamination 40. That is, magnetic particle layer 164 includes a magnetic field having a direction of magnetization that is substantially the same as a net magnetic field of the rotor lamination

In accordance with a non-limiting example, composite inserts are positioned between adjacent magnets in a magnet receiving opening and extends along the radius. The composite inserts provide additional structural support in the radial direction. The additional support allows the electric machine to employ larger more powerful magnets at higher speeds. Such an electric machine can provide more power than electric machines with unsupported rotors and, experience fewer maintenance issues.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A rotor lamination for an electric machine comprising:
a body including an axial surface, a central opening, and an outer annular edge defining a radius, a plurality of magnet receiving openings are formed in the body, each of the plurality of magnet receiving openings including a first magnet receiving portion and a second magnet receiving portion; and
a composite insert mounted in the body, the composite insert extending along the radius and across the magnet receiving opening physically separating the first magnet receiving portion from the second magnet receiving portion.

2. The rotor lamination according to claim 1, wherein the body includes a first thickness and the composite insert includes a second thickness that is greater than the first thickness.

3. The rotor lamination according to claim 1, wherein the body is formed from a first material and the composite insert is formed from a second material, the second material being distinct from the first material.

4. The rotor lamination according to claim 1, wherein the composite insert is formed from a plurality of resin impregnated layers, each of the plurality of resin impregnated layers including a plurality of fibers, at least a portion of the plurality of fibers extend along the radius of the body.

5. The rotor lamination according to claim 1, further comprising a first magnet arranged in the first magnet receiving portion and a second magnet arranged in the second magnet receiving portion.

6. The rotor lamination according to claim 5, further comprising a first amount of adhesive arranged in the first magnet receiving portion and a second amount of adhesive arranged in the second magnet receiving portion, the first and second amounts of adhesive bonding the composite insert, the first magnet, and the second magnet to the body.

7. The rotor lamination according to claim 1, wherein the composite insert includes a first end portion, a second end portion, and an intermediate portion extending between the first end portion and the second end portion, each of the first end portion and the second end portion including magnetic particles.

8. The rotor lamination according to claim 1, wherein the composite insert includes a magnetic particle layer that includes a magnet field having a direction of magnetization that is substantially the same as a net magnetic field of the rotor lamination.

9. An electric machine comprising:
a housing;
a stator mounted to the housing; and
a rotor rotatably mounted in the housing and surrounded by the stator, the rotor being formed from a plurality of rotor laminations, each of the plurality of rotor laminations comprising:
a body including an axial surface, a central opening, and an outer annular edge defining a radius, a plurality of magnet receiving openings are formed in the body, each of the plurality of magnet receiving openings including a first magnet receiving portion and a second magnet receiving portion; and
a composite insert mounted in the body, the composite insert extending along the radius and across the magnet receiving opening physically separating the first magnet receiving portion from the second magnet receiving portion.

10. The electric machine according to claim 9, wherein the body includes a first thickness and the composite insert includes a second thickness that is greater than the first thickness.

11. The electric machine according to claim 9, wherein the body is formed from a first material and the composite insert is formed from a second material, the second material being distinct from the first material.

12. The electric machine according to claim 9, wherein the composite insert is formed from a plurality of resin impregnated layers, each of the plurality of resin impregnated layers including a plurality of fibers, at least a portion of the plurality of fibers extending along the radius of the body.

13. The electric machine according to claim 9, further comprising a first magnet arranged in the first magnet receiving portion and a second magnet arranged in the second magnet receiving portion.

14. The electric machine according to claim 13, further comprising a first amount of adhesive arranged in the first magnet receiving portion and a second amount of adhesive arranged in the second magnet receiving portion, the first and second amounts of adhesive bonding the composite insert, the first magnet, and the second magnet to the body.

15. The electric machine according to claim 9, wherein one or more of the plurality of laminations includes an adhesive material arranged on the body, the adhesive material joining the one or more of the plurality of laminations to others of the plurality of laminations.

16. The electric machine according to claim 9, wherein the composite insert includes a first end portion, a second end portion, and an intermediate portion extending between the first end portion and the second end portion, each of the first end portion and the second end portion including magnetic particles.

17. The electric machine according to claim 9, wherein the composite insert includes a magnetic particle layer that includes a magnet field having a direction of magnetization that is substantially the same as a net magnetic field of the rotor lamination.

18. A method of forming a rotor for an electric machine comprising:
installing a composite insert into each of a plurality of magnet receiving openings formed in a body of a rotor lamination, the composite insert extending along a radius of the body;
aligning a plurality of rotor laminations; and
compressing the plurality of rotor laminations causing each composite insert to lock into the body.

19. The method of claim 18, further comprising adding adhesive to the body of one or more of the plurality of laminations.

20. The method of claim 18, wherein compressing the plurality of rotor laminations reduces a thickness of the composite insert.
